(19) United States
(12) Patent Application Publication
(10) Pub. No.: US 2021/0112897 A1
(43) Pub. Date: Apr. 22, 2021

(54) GARMENTS INCLUDING ELASTIC COMPOSITE FABRIC

(71) Applicant: The LYCRA Company LLC, Wilmington, DE (US)

(72) Inventor: Douglas K. FARMER, Greensboro, NC (US)

(73) Assignee: The LYCRA Company LLC, Wilmington, DE (US)

(21) Appl. No.: 17/131,858

(22) Filed: Dec. 23, 2020

Related U.S. Application Data
(63) Continuation-in-part of application No. 14/758,376, filed on Jun. 29, 2015.
(60) Provisional application No. 61/746,700, filed on Dec. 28, 2012.

(51) Int. Cl. A41D 31/18; A41D 27/00; A41C 3/12; B32B 5/26; B32B 7/09; B32B 7/14

(52) U.S. Cl. CPC A41D 31/185; A41D 27/00; A41C 3/12; B32B 5/26; B32B 2262/0207; B32B 7/14; B32B 2250/40; B32B 2437/00; B32B 2250/20; B32B 7/09

(57) ABSTRACT

Included is a stretchable fabric composite laminate, which includes two outer layers of fabric with a bonded inner layer of elastomeric fibers. The stretchable fabric composite laminate is attached to the garment fabric as an edgeband or strap or within an edgeband or strap to provide a more comfortable garment or greater fit range.

This patent application is a continuation-in-part of U.S. application Ser. No. 14/758,376 filed Jun. 29, 2015 which is the U.S. National Stage of PCT/US2013/077395 filed Dec. 23, 2013 which claims the benefit of priority from U.S. Provisional Application Ser. No. 61/746,700, filed Dec. 28, 2012, the content of each of which is herein incorporated by reference in its entirety.

### BACKGROUND OF THE INVENTION

### Field of the Invention

The present invention relates to fabrics and garments including at least one stretchable fabric composite laminate. The stretchable fabric composite laminate may be located at an edgeband, a strap or anywhere in the garment where additional stretch, elastic modulus, or support is desired.

### Summary of Related Technology

Interfacing is a woven or non-woven material that can be used in garment manufacture to provide stiffness to garment edge bands, such as waistbands, cuffs, and collars. However, these are generally not stretchable/elastic and therefore restrict the ability of the finished garment edging to stretch and recover. Some degree of stretch in waistbands and other garment openings is desirable to enhance comfort of the garment wearer or provide a greater fit range. In addition, support and stretch can be useful at any location within a garment for stretch and/or support.

### SUMMARY OF THE INVENTION

In one embodiment is a garment 1 including at least one layer of a garment fabric 2 and a stretchable fabric composite laminate 3. The stretchable fabric composite laminate includes two outer layers of fabric 4a, 4b with a bonded inner layer of elastomeric fibers 5, where the stretchable fabric composite laminate is attached to the garment fabric. See FIG. 1. The outer layers of the composite may be any suitable fabric such as a woven, knit or nonwoven. The inner layer of elastomeric fibers may be in any suitable orientation. One suitable orientation includes where the elastomeric fibers are aligned substantially parallel to each other. The composite may be attached by any suitable method, including but not limited to, adhesive, bonding, sewing, etc.

### BRIEF DESCRIPTION OF THE FIGURES

FIG. 1 provides a cross-sectional view of a garment of the present invention inclusive of the garment fabric and stretchable fabric composite laminate with two outer layers of fabric and a bonded inner layer of elastomeric fibers.

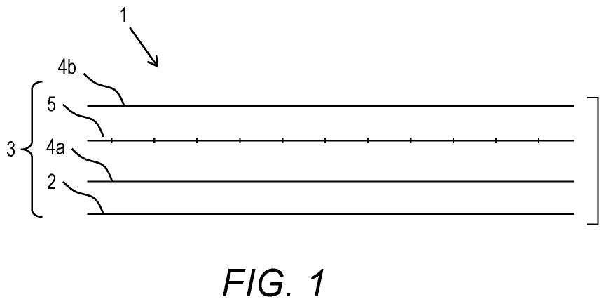

FIG. 2, views A, B, C, D and E show nonlimiting examples of garments, namely a bottom (view A), a glove (view B), headwear (view C), hosiery (view D) and a top (view E) with the stretchable fabric composite laminate attached to the garment fabric at an opening or edgeband.

### DETAILED DESCRIPTION OF THE INVENTION

As used herein, the term “fabric” refers to a knitted, woven or nonwoven material. The knitted fabric may be flat knit, circular knit, warp knit, narrow elastic, and lace. The woven fabric may be of any construction, for example sateen, twill, plain weave, oxford weave, basket weave, and narrow elastic. The nonwoven material may be meltblown, spun bonded, wet-laid, carded fiber-based staple webs, and the like.

As used herein, the term “modulus” refers to a ratio of the stress on an item expressed in force per unit linear density or area.

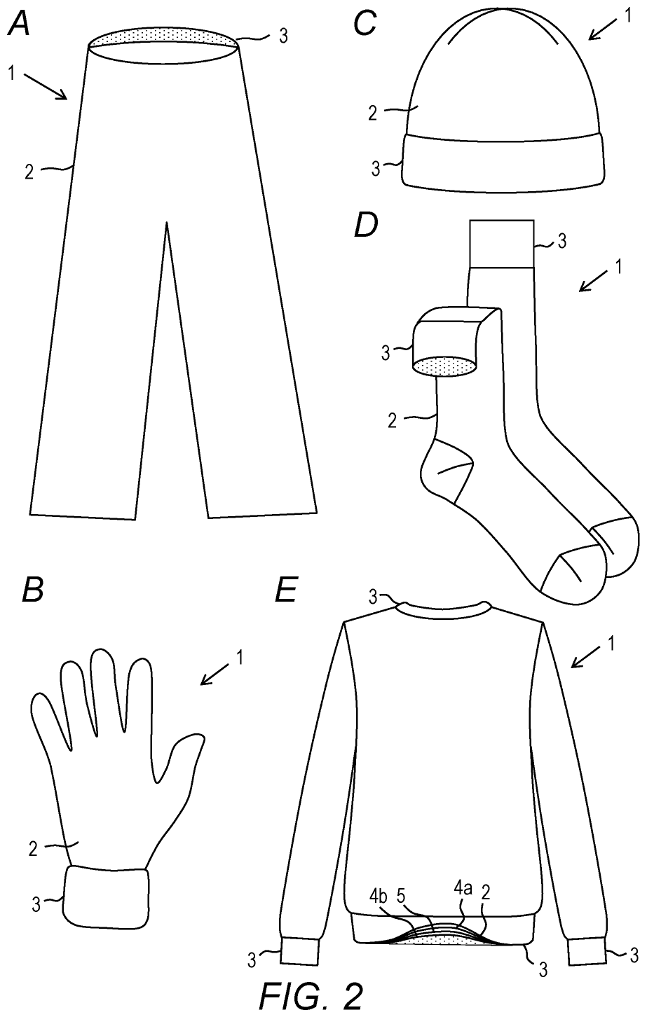

In some embodiments are articles including a garment that has at least one opening that may be include an edgeband that includes a polyurethaneurea composition. Such garments may include tops (FIG. 2E), bottoms (FIG. 2A), hosiery (FIG. 2D), seamless garments, headwear (FIG. 2C), underwear and gloves (FIG. 2B).

In some embodiments is an article including a garment having at least one opening. The opening is also referred to as an edgeband. The edgeband may be included with a variety of different garments that include, but are not limited to, waistbands (FIG. 2A), cuffs (FIG. 2E) and other arm openings and armbands (FIG. 2B), collars/neck openings (FIG. 2E), headbands (FIG. 2C), thigh highs, sock tops (the opening of a sock; FIG. 2D), leg warmers, wristbands, headbands, leg openings (legbands), and hems, among others. The stretchable composite laminate may be attached to a surface of the opening, such as the inner body contacting surface, or may be included with a multiple layer opening, such as a single foldover of fabric or a multiple layered fabric construction such as a waistband. In multiple layer edge bands, the stretchable composite laminate may be an intermediate layer or may be included on a fabric surface, including a body-contacting surface. Alternatively, the band of material may be on an exposed or outer surface. If the band is visible, it may be printed, dyed or calendared to give it a desirable appearance.

A stretchable composite laminate as describe herein may have any suitable width. An example of a suitable range includes, but is not limited to about 0.1 cm to about 30.0 cm. When smaller widths are included, such as about 1.0 cm to about 5.0 cm, the stretchable composite laminate may form a strap for a garment, such as a brassiere or a swimsuit.

In another embodiment, a single layer of a fabric may be folded to form two or more layers of a multiple layer article with a stretchable composite laminate as an intermediate layer. Where a stretchable composite laminate is placed at the point of folding, it may provide additional stretch recovery power, such as at a hem, or for a body shaping garment, to provide additional support.

Any type of fabric may be used as the garment or in an edgeband. This includes woven, nonwoven, knit, and lace fabrics, among others. The stretchable composite laminate may be placed adjacent to one surface of the garment or between layers within the garment. The stretchable fabric composite laminate may be prepared separately and sewn to the garment or the stretchable fabric composite laminate may be incorporated into the garment opening during construction of the garment. Dyeing and finishing of the garment may be conducted before or after assembly of the garment with the stretchable composite laminate.

There are some benefits to attaching the garment or edgeband to the stretchable composite laminate prior to fabric finishing. One example is where in a garment, fabrics, including 100% cotton fabrics, tend to shrink upon fabric finishing. By including a stretchable composite laminate in a garment, growth of the fabric is resisted in addition to the benefits of added elasticity and vertical stability.

In order to add additional support and other features, the stretchable composite laminate may be added to different areas of the article. For example, it may either extend through the entire area of the edgeband (continuous application) or to a selected portion or portions (discontinuous application) to provide different benefits. For example, pieces of the stretchable composite laminate may be placed in selected locations throughout the area of the opening or edge band.

One suitable method for accomplishing the attachment of the outer layers with inner elastomeric fibers of the stretchable fabric composite laminate it to apply an adhesive dispersion or solution to a fabric. The application may be by any of a variety of different methods. Methods for applying the dispersions or solutions of polyurethaneurea include spraying, kissing, printing, brushing, dipping, padding, dispensing, metering, painting, and combinations thereof. This may be followed by application of heat and/or pressure.

A variety of useful adhesives may be included in the stretchable fabric composite laminate. Examples of adhesives include any hot melt adhesive, a cyanoacrylate, an epoxy, polyvinyl acetate, a plastisol (including rubber), a thermoplastic (including polyurethanes, polyesters, and polyamides), silicone, a polyurethaneurea aqueous dispersion, a thermoset, a pressure sensitive adhesive and combinations thereof. The adhesive may be used to form the stretchable fabric composite laminate and/or to attach the laminate to a garment. The adhesive may include a continuous or discontinuous application. Examples of discontinuous application of adhesive include the group consisting of dots, vertical lines, horizontal lines, diagonal lines, a grid, and combinations thereof. An example of a commercially available hot melt adhesive in a dot configuration is available under the tradename Pinbond®, by Freudenberg Gygli GmbH, Weinheim, Germany and is useful for bonding elastic textiles. Moreover, the polyurethaneurea aqueous dispersions may also be used as an adhesive to adhere more than one layer of any the garment or polyurethaneurea film as described in some embodiments.

A variety of different fibers and yarns may be used with the fabrics and garments of some embodiments. These include cotton, wool, acrylic, polyamide (nylon), polyester, spandex, regenerated cellulose, rubber (natural or synthetic), bamboo, silk, soy or combinations thereof.

Additives that may be optionally included in the stretchable fabric composite laminate include: anti-oxidants, UV stabilizers, colorants, pigments, crosslinking agents, phase change materials (i.e., Outlast®, commercially available from Outlast Technologies, Boulder, Colo.), antimicrobials, minerals (i.e., copper), microencapsulated well-being additives (i.e., aloe vera, vitamin E gel, aloe vera, sea kelp, nicotine, caffeine, scents or aromas), nanoparticles (i.e., silica or carbon), calcium carbonate, flame retardants, antitack additives, chlorine degradation resistant additives, vitamins, medicines, fragrances, electrically conductive additives, and/or dye-assist agents (i.e., Methacrol®, commercially available from E. I. DuPont de Nemours, Wilmington, Del.). Other additives which may be added to the prepolymer or the aqueous dispersion comprise adhesion promoters, anti-static agents, anti-cratering agents, anti-crawling agents, optical brighteners, coalescing agents, electroconductive additives, luminescent additives, flow and leveling agents, freeze-thaw stabilizers, lubricants, organic and inorganic fillers, preservatives, texturizing agents, thermochromic additives, insect repellants, and wetting agents.

Aqueous polyurethane dispersions may also be included as an adhesive. These are particularly suitable for adhesive shaped articles, which can be used for fabric bonding, lamination, and adhesion purposes when applied with heat and pressure for a relatively short period of time. Pressures, can for example, range from about atmospheric pressure to about 60 psi and times can range from less than about one second to about 30 minutes in accordance with the bonding method used.

Lamination can be carried out to secure the composite to a fabric using any method wherein heat is applied to the laminate surface. Methods of heat application include, for example, ultrasonic, direct heat, indirect heat, and microwave. Such direct lamination may provide an advantage in view of other methods used in the art in that the shaped article may not only bond to the a substrate via a mechanical interaction but also via a chemical bond. For example, if the substrate has any reactive hydrogen functional groups, such groups may react with the isocyanate and hydroxyl groups on the dispersion or shaped article, thereby providing a chemical bond between the substrate and the dispersion or shaped article. Such chemical bonding of the dispersion or shaped article to the substrate can give a much stronger bond. Such bonding may occur in dry shaped articles that are cured onto a substrate or in wet dispersions that are dried and cured in one step. Materials without an active hydrogen include polypropylene fabrics and anything with a fluoropolymer or a silicone based surface. Materials with an active hydrogen include, for example, nylon, cotton, polyester, wool, silk, cellulosics, acetates, metals, and acrylics. Additionally, articles treated with acid, plasma, or another form of etching may have active hydrogens for adhesion. Dye molecules also may have active hydrogens for bonding.

Methods and means for applying the adhesive of some embodiments include, but are not limited to: roll coating (including reverse roll coating); use of a metal tool or knife blade (for example, pouring a dispersion onto a substrate and then casting the dispersion into uniform thickness by spreading it across the substrate using a metal tool, such as a knife blade); spraying (for example, using a pump spray bottle); dipping; painting; printing; stamping; and impregnating the article. These methods can be used to apply the dispersion directly onto a substrate without the need of further adhesive materials and can be repeated if additional/heavier layers are required. The dispersions can be applied to any fabrics of knits, wovens or nonwovens made from synthetic, natural, or synthetic/natural blended materials for coating, bonding, lamination and adhesion purposes. The water in the dispersion can be eliminated with drying during the processing (for example, via air drying or use of an oven), leaving the precipitated and coalesced polyurethane layer on the fabrics to form an adhesive bond.

An example of a tool that can be used for applying dispersions is a knife blade. The knife blade can be made of metal or any other suitable material. The knife blade can have a gap of a predetermined width and thickness. The gap may range in thickness, for example, from 0.2 mils to 50 mils, such as a thickness of 5 mils, 10 mils, 15 mils, 25 mils, 30 mils, or 45 mils.

The thickness of the films, solutions, and dispersions may vary depending on the application. In the case of dry shaped articles, the final thickness may, for example, range from about 0.1 mil to about 250 mil, such as from about 0.5 mil to about 25 mil, including from about 1 to about 6 mil (one mil=one thousandth of an inch).

Suitable thicknesses include about 0.5 mil to about 12 mil, about 0.5 to about 10 mil, and about 1.5 mil to about 9 mil. For aqueous dispersions, the amount used may, for example, range from about 2.5 g/m² to about 6.40 kg/m², such as from about 12.7 to about 635 g/m², including from about 25.4 to about 152.4 g/m².

Examples of apparel or garments that include a stretchable composite laminate, include but are not limited to: undergarments, brassieres, panties, lingerie, swimwear, shapers, camisoles, hosiery, sleepwear, wetsuits, scrubs, space suits, uniforms, hats, garters, sweatbands, belts, activewear, outerwear, rainwear, cold-weather jackets, pants, shirtings, dresses, blouses, mens and womens tops, sweaters, corsets, vests, knickers, socks, knee highs, thigh highs, dresses, blouses, aprons, tuxedos, bisht, abaya, hijab, jilbab, thoub, burka, cape, costumes, diving suit, kilt, kimono, jerseys, gowns, protective clothing, sari, sarong, skirts, spats, stola, suits, straitjacket, toga, tights, towel, uniform, veils, wetsuit, medical compression garments, bandages, suit interlinings, waistbands, and all components therein.

A suitable stretchable nonwoven laminate which is useful for the garments of the present invention is disclosed in U.S. Pat. No. 6,713,415, which is incorporated by reference in its entirety. This includes the fabric described as follows:

The stretchable fabric composite laminate of some aspects is composed of two outer layers of nonwoven fabric of substantially equal width and a uniform inner layer of substantially parallel, equally spaced elastomeric fibers of equal decitex which are capable of complete recovery from extensions as great as 300%. The elastomeric fibers can be substantially completely relaxed in the absence of externally applied forces. Knit or woven fabric may be used in place of the nonwoven.

“Uniform inner” layer means that the fibers are of substantially equal decitex and spacing, are substantially parallel to each other, and are subjected to substantially the same tension during preparation of the composite fabric.

The fabrics can have a basis weight ranging from about 10 to about 30 g/m2. Many types of fabrics, including nonwoven fabrics, are suitable. Representative examples are nonwovens composed of thermally bonded, spunbonded and hydroentangled fibers, and the two outer layers can be the same or different. For example, they are composed of synthetic polymeric fibers such as polyolefin, polyester and polyamide fibers.

The layer of elastomeric fibers is composed of at least eight threadlines per inch (3.15 threadlines/cm) of width, each threadline being at least 400 decitex. For example, the number of threadlines per inch is not greater than 16 (6.30 threadlines/cm) or it is 12. The combination of these two parameters may be chosen to provide a minimum retractive force of about 0.22 pounds per inch (38.9 g/cm), as measured in the finished product when it is stretched at 150% of its original length. The elastomeric fibers are substantially parallel to the edges of the nonwoven fabrics. One suitable elastomeric fiber is spandex fiber.

The three layers may be bonded together by an adhesive composition which constitutes from about 10% to about 35% of the weight of the composite fabric. Alternatively, adhesive content in the composite above these levels can make the fabric bond to itself. The adhesive compositions can be hot melt adhesives, such as styrene-based block copolymers, including styrene/isoprene and styrene/butadiene block copolymers. The styrene-based portions may be at least about 30 wt % of the total adhesive. Each element (layer) in the composite is bonded to at least one other element of the composite. The adhesive only partially covers the inside surface of the outer fabric layer. The adhesive penetrates to the outside of each outer layer to an extent less than about 10% based on the surface area of each outer layer. “Inside surface” refers to a nonwoven layer surface that is within the composite fabric of the invention.

The composite stretchable puckered fabric can be prepared by placing between two layers of nonwoven fabric uniformly tensioned elastomeric filaments which are spaced a substantially equal distance apart and are of substantially equal decitex no less than 400 decitex per filament. There may be at least 8 filaments (threadlines) per inch of width and the threadlines are substantially parallel to each other and to the edges of the nonwoven fabrics. The three layers are bonded with an adhesive followed by removing the tension after bonding. This process produces a puckered fabric having a substantially uniform flat surface appearance which results from small substantially uniform puckers.

In a suitable process for preparing the puckered fabric, a layer of substantially parallel and equally spaced elastomeric fibers is stretched not less than 100% and placed on top of one of the layers of nonwoven fabric. An adhesive, such as a hot melt adhesive, is applied onto the elastomeric fibers and bottom nonwoven layer. The other layer of nonwoven is then placed on top of the adhesive-treated combination and the combined structure is bonded by heat and pressure while the elastomeric fibers remain in the stretched condition. Alternatively, the adhesive can be applied to the elastomeric fibers prior to their placement between layers of nonwoven fabric. When the bonding is completed, the tension is substantially completely released and the composite fabric relaxes to form the desired puckered structure.

The hot melt adhesive can be applied in several different ways. In one method, the melted adhesive can be deposited as a discontinuous web from a spray nozzle, a process known as melt blowing. In another method, the melted adhesive can be deposited as a solid stream from a nozzle which moves in a spiral pattern as the web passes, a process known as spiral spray. A pattern in which the adhesive only partially covers an inside surface of nonwoven layers, such as is produced by melt-blowing or spiral spray, results in a uniform, flat surface appearance of the composite fabric. By “partially covers” it is meant that the adhesive is present at one part of the inside surface of the nonwoven but absent at an adjacent part. This can also be accomplished by applying a “dot matrix” pattern, as well.

The products of this invention provide a desirably smooth, tailored appearance and are useful primarily as insert elastic nonwovens, for example, as the elastic inserts in outerwear shorts.

The flatness or smoothness of the puckered fabrics of this invention can be measured by measuring the change in thickness when the fabric is stretched from its relaxed state to its ultimate elongation. The smoother the appearance of the fabric, the smaller the change in thickness on stretching. The percent decrease in thickness in one aspect is not greater than about 64%. Alternatively, one can count the number of raised portions, referred to as puckers, per linear inch of the relaxed composite fabric. Starting from a given extended length, as the number of puckers increases in the relaxed fabric, the amplitude of each pucker decreases. Fabrics with acceptable smoothness have at least 16 puckers per linear inch (6.3 puckers/cm).

A relationship of these two values, the ratio of percent decrease in thickness to the number of puckers per inch, defines the fabric of this invention well. This ratio, referred to as the flatness factor, must be about 4.4 or less, including less than 3.6, for a stretchable fabric to meet the limitation of substantially uniform flat appearance of this invention.

While the present invention has been described in an illustrative manner, it should be understood that the terminology used is intended to be in a nature of words or description rather than of limitation. Furthermore, while the present invention has been described in terms of several illustrative embodiments, it is to be appreciated that those skilled in the art will readily apply these teachings to other possible variations of the invention.

What is claimed is:

1. A garment including at least one layer of a garment fabric and a stretchable fabric composite laminate;
said stretchable fabric composite laminate including two outer layers of fabric with a bonded inner layer of elastomeric fibers;
wherein said stretchable fabric composite laminate is attached to said garment fabric to provide stiffness and vertical stability and stretch and recovery to the garment fabric while resisting growth.

2. The garment of claim 1, wherein said stretchable fabric composite laminate is attached to said garment fabric by bonding, adhering, sewing, laminating or a combination thereof.

3. The garment of claim 1, wherein said elastomeric fiber comprises melt-spun elastomer.

4. The garment of claim 1, wherein said elastomeric fibers are selected from the group consisting of spandex, elastomeric polyolefin, natural rubber filament, and synthetic rubber filament, and combinations thereof.

5. The garment of claim 1, wherein said garment is selected from the group consisting of tops, bottoms, hosiery, seamless garments, headwear, intimate apparel, swimwear and gloves.

6. The garment of claim 5, wherein said stretchable fabric composite laminate is included at an edgeband of said garment.

7. The garment of claim 6, wherein said edgeband is selected from the group consisting of an armband, a cuff, a collar, a waistband, a legband, a headband, and a hem.

8. The garment of claim 1, wherein said garment includes a component which includes said stretchable fabric composite laminate.

9. The garment of claim 8, wherein said component of said garment is selected from the group consisting of a brassiere wing, a shaper panel and a strap.

10. The garment of claim 1, wherein said garment includes two or more layers of said garment fabric and said stretchable fabric composite laminate is located between said layers.

11. The garment of claim 10, wherein said two or more layers are formed by folding a single piece of fabric.

12. The garment of claim 1, wherein said stretchable fabric composite laminate is attached to said garment fabric by an adhesive between said garment fabric and said stretchable fabric composite laminate.

13. The garment of claim 10, wherein the adhesive comprises a discontinuous application.

14. The garment of claim 13, wherein said discontinuous application is selected from the group consisting of dots, vertical lines, horizontal lines, diagonal lines, a grid, and combinations thereof.

15. The garment of claim 14, wherein said adhesive is selected from the group consisting of a hot melt adhesive, a cyanoacrylate, an epoxy, polyvinyl acetate, a plastisol, a thermoplastic, silicone, a polyurethane aqueous dispersion, and combinations thereof.

16. The garment of claim 1, wherein said stretchable fabric composite laminate is laundry-durable.

17. The garment of claim 1, wherein said stretchable fabric composite laminate has a width of about 0.20 cm to about 30.0 cm, including from about 0.30 cm to about 10.0 cm.

18. The garment of claim 1, wherein said two outer layers of nonwoven fabric included in said stretchable fabric composite laminate are of substantially equal width; and
each outer layer of said stretchable fabric composite laminate has an inside surface and an outside surface with respect to the stretchable fabric composite laminate; and
said inner layer of elastomeric fibers includes at least 8 threadlines/inch (3.15 threadlines/cm); and
the elastomeric fibers have a linear density of about 400 decitex or greater.

19. The garment of claim 18, wherein the elastomeric fibers have a linear density of 800 decitex to about 2500 decitex.

20. The garment of claim 18, wherein said stretchable fabric composite laminate has a retractive force of about 0.22 lb/inch (38.9 g/cm).

21. The garment of claim 1, wherein said stretchable fabric composite laminate includes an adhesive in an amount of about 10% to about 35% by weight of the stretchable fabric composite laminate.

22. The garment of claim 21, wherein said adhesive only partially covers the inside surface of at least one outer layer and penetrates to the outside of each outer layer to an extent less than about 10% based on the surface area of each outer layer.

23. The garment of claim 1, wherein the stretchable fabric composite laminate has a calculated flatness factor of not more than 4.4.
